(19) United States
(12) Patent Application Publication
(10) Pub. No.: US 2004/0252184 A1
(43) Pub. Date: Dec. 16, 2004

(54) Video visitation station

(76) Inventors: Thomas H. Hesse, Mesa, AZ (US); Keith A. Weaver, El Mirage, AZ (US)

Correspondence Address: SQUIRE, SANDERS & DEMPSEY L.L.P., Two Renaissance Square, Suite 2700, 40 North Central Avenue, Phoenix, AZ, 85004-4440, US

(21) Appl. No.: 10/462,877

(22) Filed: Jun. 16, 2003

(51) Int. Cl. H04N 7/14

(52) U.S. Cl. 348/14.01

(57) ABSTRACT

A video visitation station according to various aspects of the present invention includes a first wall and a second wall set at an angle to each other and connected at one end by a connector, forming an essentially trapezoidal enclosure. A video cabinet is secured to the first wall and second wall. The video cabinet contains the video conferencing equipment. The video visitation station can accommodate multiple users.

### TECHNICAL FIELD OF THE INVENTION

This invention relates to the field of video conferencing systems and, more particularly to an improved video visitation station

### BACKGROUND OF THE INVENTION

There is often a need to provide secure communication between people. One example is the communication between a prisoner and a visitor such as the prisoner's attorney or relative. Traditionally, these interactions have occurred in person with the participants divided by a barrier such as glass in an area secured by guards. These procedures have several drawbacks. First, there is always the potential that in person communications can lead to the transfer of contraband. This can, of course, lead to further problems in the prison. Second, monitoring in person communications is time consuming and labor intensive. Guards must be ever vigilant to stop the passing of contraband, such as weapons or drugs, between the participants to the conversation. Third, there are times when the participants to the conversation may be geographically separated making it difficult or impossible to have in person conversations. This is especially true with the recent move to privatize prisons. This has resulted in prisoners serving their sentences in different states from where they were sentenced. Thus, relatives, lawyers and others may not be able to communicate with the prisoner.

This has lead to the development of different ways to allow for remote communications between individuals. One way to provide the communication is by the use of a video conference system. These video conference systems provide each party with a camera, a microphone, a speaker and a video screen. The first party's images and speech are transmitted to the screen and speaker of the second party, and vice versa. In this manner the conversations can occur with the participants located anywhere.

One challenge in providing a video conference system is that in areas where a large number of visitation stations are needed, such as in an inmate visitation area, space is at a premium. Typical deployments of video conference systems take up a large amount of space resulting in less video conference stations in a given area.

Additionally, present video conference stations are often not strong enough to take the abuse of use in public places such as an inmate visitation room. Also, current video conference stations are not easily fixed when damaged. Thus, there is a need for a space efficient, rugged video visitation station.

### SUMMARY OF THE INVENTION

A video visitation station according to various aspects of the present invention includes a first wall and a second wall set at an angle to each other and connected at one end by a connector, forming an essentially trapezoidal enclosure. A video cabinet is secured to the first wall and second wall. The video cabinet contains the video conferencing equipment. The video visitation station can accommodate multiple users.

Multiple video visitation stations can be connected together to form a line of video visitation stations, each usable for a different video conference. In one embodiment, each of the multiple video visitation stations share a common wall that is secured to another wall at both ends of the common wall by a connector. The entrances to each of the video visitation systems alternate on either side of the line of video visitation stations.

Alternatively, the video visitation stations can be arranged in a line in which all of the entrances to the video visitation stations are on the same side of the line. In this embodiment, each station would not necessarily share the same wall.

### BRIEF DESCRIPTION OF THE DRAWINGS

Embodiments of the present invention will now be further described with reference to the drawings, wherein like designations denote like elements, and;

FIG. 1 is a perspective view of a video visitation station according to various aspects of the present invention;

FIG. 2 is a top view of a video visitation station;

FIG. 3a-3b are a view of the wall frame and the wall frame covered in part by skin panels;

FIG. 4 is view of the video cabinet contained within the video visitation station;

FIG. 5 is a perspective view of multiple video visitation stations

FIG. 6 is a top view of multiple video visitation stations; and

FIG. 7 is a view of an alternative design for multiple video visitation stations.

### DETAILED DESCRIPTION OF THE PREFERRED EMBODIMENT

A visitation system according to various aspects of the present invention provides a video conference station that is able to withstand physical abuse. As such it is useful in places such as public places and prison. The visitation system includes a video conference cabinet enclosed by a first side wall and a second side wall. The first side wall and second side wall are angled towards each other and connected at one end with a corner connector. The video conference cabinet contains video conferencing equipment and seating space for two or more visitors.

A visitation system according to various aspects of the present invention provides two or more video conference stations connected together. In one embodiment, multiple stations are connected with one station having an opening on a first side and a second station having an opening on a second side. Each station shares a common wall secured on either end by a connector. In a second embodiment multiple stations are aligned in a row with the entrances for each station on the same side.

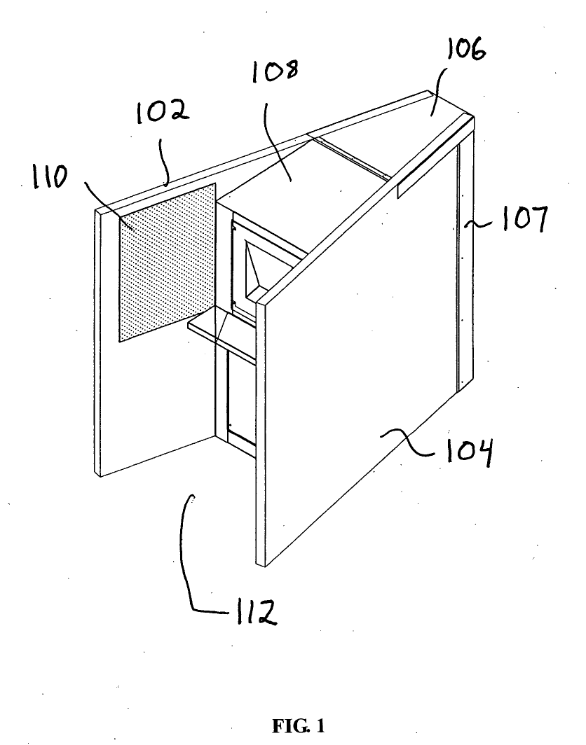

For example, a single visitation station 100 as seen in FIGS. 1-4 includes a first side wall 102 having an inside portion 202 and an outside portion 204 and a second side wall 104 having an inside portion 202 and an outside portion 204 coupled at one end by a connector 106 and a corner post 107. The other end is open and forms the entrance 112 of the visitation station 100. An acoustical grating 110 may be included on the inside portion 202 of first side wall 102 and the inside portion 206 of second side wall 104.

First and second side walls 102 and 104 are made from a strong material, preferably a metallic material such as steel. In one embodiment, each side wall is six feet long, five feet high and 2 inches wide with the distance between the two side walls are between fourty and forty two inches at the entrance to the visitation station 100. The length and height of the side walls can vary to accommodate different size stations.

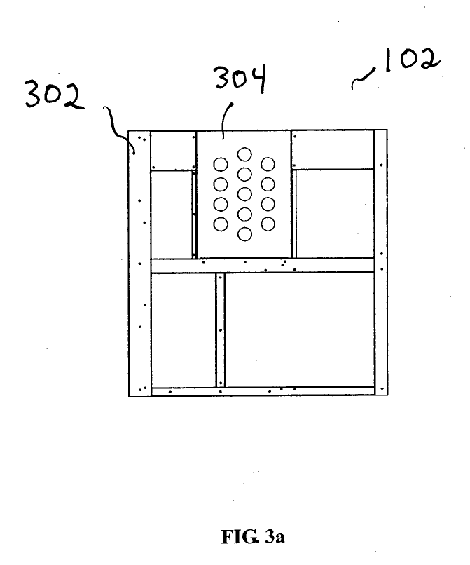

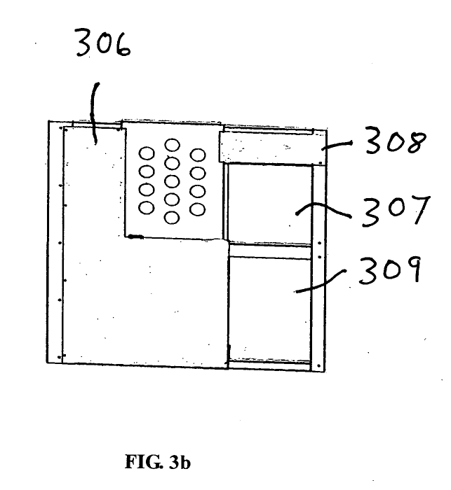

First and second side walls 102 and 104 are built on a frame 302 as seen in FIGS. 3a-3b. Frame 302 gives structural support to first and second side walls 102 and 104. The frame 302 is bolted to the floor to permanently install the first and second side walls 102 and 104. Frame 302 includes acoustical panel 304, which is secure to frame 302 via welding or fastening to the other portions of frame 302. Acoustical foam (not pictured), comprising such material as fiberglass insulation or other sound absorbing materials, can be placed within the acoustical panel 304, which is then covered by acoustical grating 110. The combination of the acoustical panel 304, acoustical foam and the acoustical grating 110 help to keep the sound produced in one station by individual conversation from interfering with other conversations.

To cover frame 302, metal skins are attached over frame 302. The inside portions 202 and 206 of first and second side wall 102 and 104 are shown in FIG. 3a and 3b. Referring to FIG. 3b, a first skin 306 and a second skin 308 are installed over the frame 302. First and second skin 306 and 308 in one embodiment can be attached to frame 302 using rivets or security fasteners, although any fastening method such as bolting, screwing, welding and the like can be used. The skin can alternatively be installed using bolts that are welded to or pressed on to the inside of the skin, minimizing exposed hardware, especially in areas where the users spends a great deal of time. In one embodiment the frame is manufactured from sixteen gauge steel and the covered by stainless steel skins, although different types and thicknesses of steel can be used.

Referring to FIG. 3b, frame 302 includes open sections 307 and 309 that are not covered by metal skin. The equipment cabinet 108 attaches to this portion of frame 302, thereby covering the open sections 307 and 309. The other side of frame 302, as shown in FIGS. 3a and 3b, which is the outside portion 204 of first side wall 102 and outside portion 208 of the second side wall 104, is covered, in one embodiment, by a single metal skin. Note that the first skin 306 and second skin 308 overlap the acoustic panel 304 (in one embodiment by an inch of overlap). The overlap forms a pocket where the fiberglass insulation (acoustical foam) and the acoustical grating 110 can be installed without the use of tools.

In one embodiment, first and second side wall 102 and 104 are deployed in a non-parallel, converging configuration in which the first and second side wall 102 and 104 come together at one end but do not touch. First and second side wall 102 and 104 are coupled using connector 106 and corner post 107. Connector 106, in one embodiment, has a generally trapezoidal shape and fits over and on top of both first and second side walls 102 and 104 and is secured by tamper proof security hardware to the first and second side walls 102 and 104.

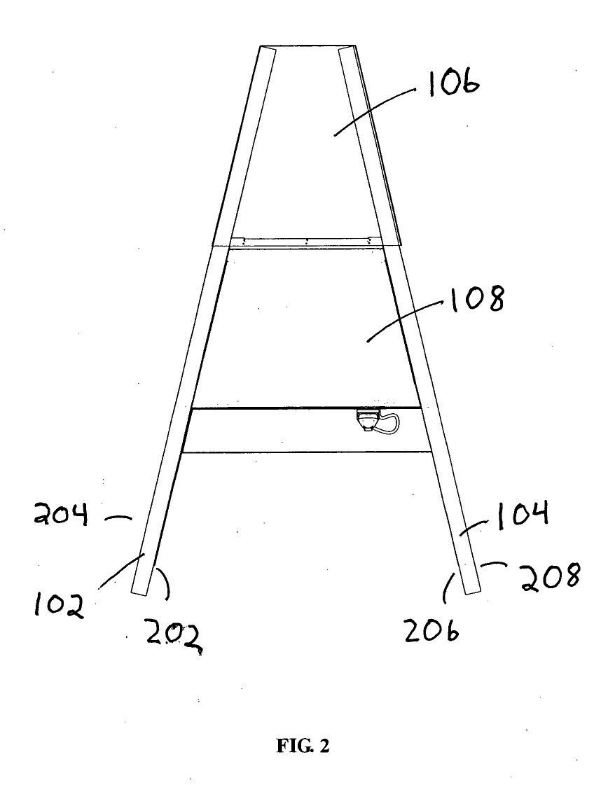

As seen in FIGS. 1 and 2, first and second side wall 102 and 104, the top of connector 106 and an imaginary line extending across the entrance 112 of visitation station 100 forms a trapezoidal configuration. In an alternative embodiment, first and second side walls 102 and 104 can be configured such that they touch at one end, forming a triangular configuration. Then a triangle shaped connector 106 would be used to secure first and second side walls 102 and 104. Varying the distance between the side walls at one end where the walls are closer together varies the distance between walls at the other end. In one embodiment, first and second side walls 102 and 104 are configured such that at least two persons can sit in front of equipment cabinet 108 to participate in a video conference. The trapezoidal configuration saves space over other designs. For example, in order to have a station with parallel walls that has the same opening, the parallel walls will be spaced uniformly apart and take up more room then the wedge design. Also, in order for the cabinet in a parallel wall configuration to be tied to each wall the cabinet would have to be as wide as the entrance.

Equipment cabinet 108 encloses and protects video conference equipment. In one embodiment, equipment cabinet 108 is made from metal such as steel. Equipment cabinet 108 includes a top 402 and a base 404. Top 402 encloses a video camera and a monitor (not pictured) for use in video conferencing. The video camera and monitor are mounted behind a front plate 406. Top 402 includes a monitor holder 408 for holding the monitor and other equipment. The monitor holder 408 can be mounted on a track such that when the fasteners holding front plate 406 are removed, the front plate 406 and monitor holder 408 can be pulled out for ease of access. Alternatively, front plate 406 can simply be removed once unfastened from top 402 and the monitor holder 408 accessed conventionally.

In one embodiment, cabinet 108 has a wedge shape, or trapezoidal, design. The wedge or trapezoidal shape allows the cabinet to fit in and be bolted to the angled first and second side walls 102 and 104. First and second side walls 102 and 104 attach to the non-parallel, slanted walls of the trapezoidal shaped cabinet 108. Referring to FIG. 2, the trapezoidal shape of top panel 403 is shown. By having the wedge shape, the cabinet itself can be bolted to the first and second side walls 102 and 104. If the cabinet 108 were a different shape some type of an adapter would have to be used, adding pieces and weakening the structure. Top panel 403 also is designed with a downward sloping angled surface such that any item placed on top would fall off.

Front plate 406 includes a transparent panel 410 mounted on a bracket 412 for protecting the enclosed monitor. In one embodiment, transparent panel 410 is made from LEXAN, developed by the General Electric Company although any strong preferably shatterproof transparent material can be used. In one embodiment, transparent panel 410 is set back at an angle. The angle of the transparent panel 410 prevents a user from getting a straight on blow if the user tried to punch transparent panel 410. In one embodiment the transparent panel 410 is set at an angle of 16.5 degrees when installed in the bracket 412. A thin scratch resistant layer can be incorporated with transparent panel 108. The thin scratch resistant layer can be a soft plastic layer. The purpose of the thin plastic layer is to allow the thin plastic layer to get scratched since it is cheaper and easier to replace. When mounted on the enclosure, the plastic layer and LEXAN panel from an air and liquid tight barrier. The thin plastic layer protects the enclosure from liquid intrusion. The transparent panel bracket 412 has an angled surface. The angled surface is angled downward towards the ground to prevent the accumulation of liquids on the transparent panel as well as keeping objects placed thereon from staying there.

A telephone handset 414 is provided at top 402 for transmitting verbal communication. Telephone handset 414 transmits and receives audible communications between the user of visitation station 100 and the other party to the video conference. Telephone handset 414 functions similarly to any conventional telephone handset. Instead of a telephone handset, other methods of audible communications can be used such as a built in microphone, voice activated or otherwise, and via speaker. Additionally, an intercom type system can be used.

Base 404 supports top 402. Base 404 includes a removable access panel 416. Various items, including communication routers, computers and the like can be stored behind removable access panel 416. In one embodiment, top 402 is welded on to base 404, although any conventional fabrication method can be used, such as making top 402 and base 404 on piece. A tray 411 is provided between top 402 and base 404. In one embodiment, tray 411 is angled down so any materials placed on tray 411 will fall off.

As seen in FIG. 1, there is acoustical grating 110 on the inside portion 202 of first side wall 102. There can also be acoustical grating on the inside portion 206 of the second side wall 104. As discussed previously, acoustical grating I IO and acoustical foam can be placed to help absorb sounds produced in the station. While one acoustical grating is shown in FIG. 1, none or more acoustical gratings can be provided.

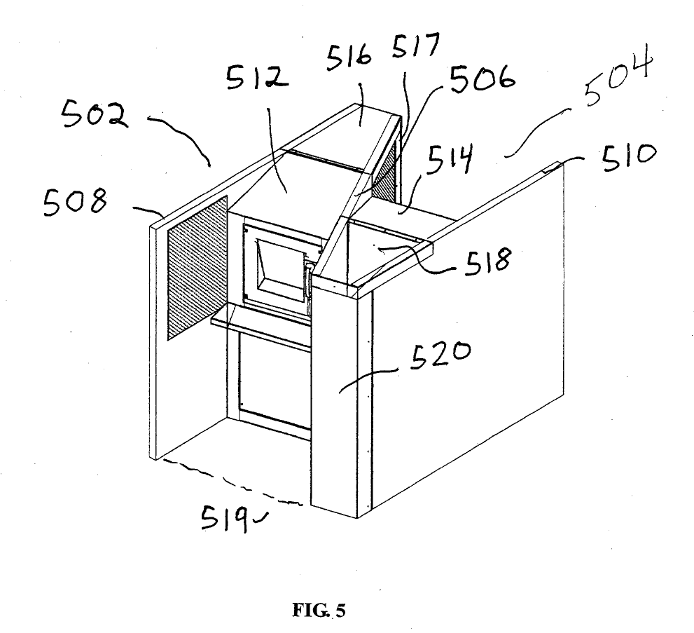

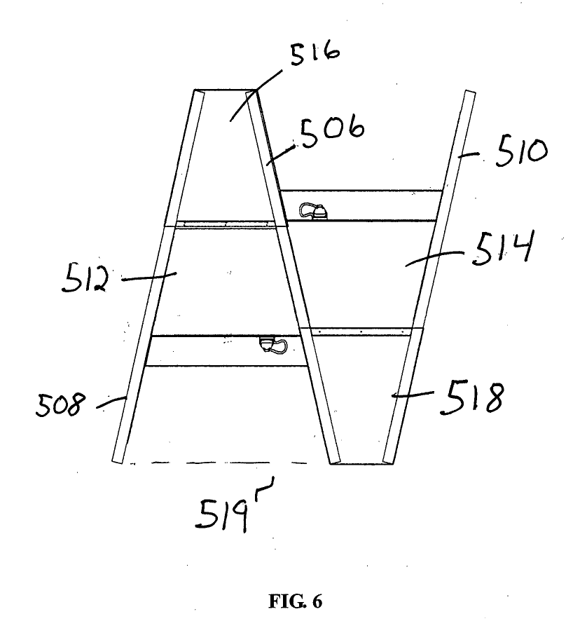

FIGS. 1-4 illustrated a single video conference station. Multiple stations can also be provided based on the single video conference. For example, multiple stations can be provided with each station sharing a common wall. Referring now to FIG. 5-6, a video visitation station 500 comprising a first station 502 and a second station 504 are illustrated. First station 502 includes a first wall 508 and a second wall 506 coupled by a connector 516 and corner panel 517. A first video equipment cabinet 512 is secured between first wall 508 and second wall 506.

Second station 504 is substantially similar to first station 502 except that users of second station 504 would be seated on the opposite side of video visitation station 500. Second station 504 includes second wall 506 and third wall 510 coupled by connector 518 and corner panel 520. A second video equipment cabinet 514 is secured between second wall 506 and third wall 510. Note that second wall 506 is common to first station 502 and second station 504. The common wall on both sides will have metal skins overlaying the frame as shown in FIG. 3b. The openings in FIG. 3b will be common to both of the stations. Thus an opening will exist between the video equipment cabinets 512 and 514 that can be used for routing cables and accessing equipment.

When viewed from above, such as in FIG. 6, in one embodiment, the walls, connectors and an imaginary line across the entrance 519 of first station 502 resembles a trapezoid. Second station 504 also resembles a trapezoid, although one that is inverted in orientation as compared to the shape of the configuration of first station 502.

While FIGS. 5-6 show two stations, multiple stations can be provided in the same manner. In the present invention, the non-parallel walls of the station and the common wall shared between each station results in a configuration for a video visitation station that takes up less space then a conventional design that utilizes rectangular configured cubicles. Also, the distance between the walls in each of the stations can be adjusted to provide a large opening where the video conferencing occurs. In one embodiment, each station can accommodate two users.

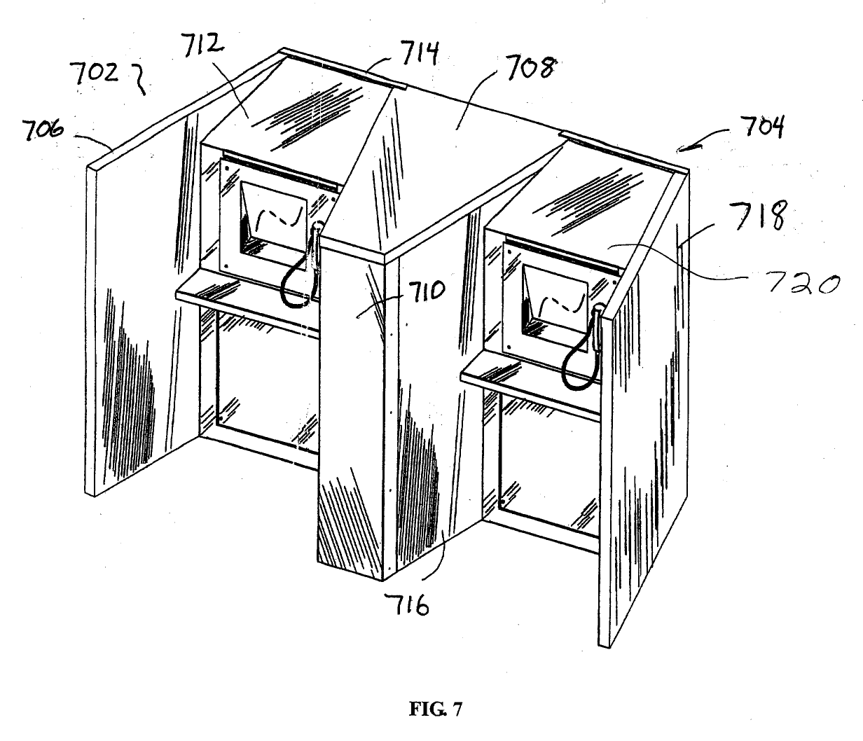

In an alternative embodiment, multiple stations can be configured in which all of the openings to the video conference equipment are on the same side of the video visitation station. Referring to FIG. 7, video conference system 700 comprises a first station 702 and a second station 704.

First station 702 includes a first wall 706 and a second wall, which is not visible in FIG. 7 because it is covered by trapezoidal top plate 708 and a corner plate 710. A video equipment cabinet 712 is coupled between the first wall 706 and the second wall. Along the back of the first video equipment cabinet 712 is a back plate 714 that couples first wall 706, first video equipment cabinet 712 and trapezoidal top plate 708, In one embodiment, back plate 714 is a strip of metal installed along the top of first station 702.

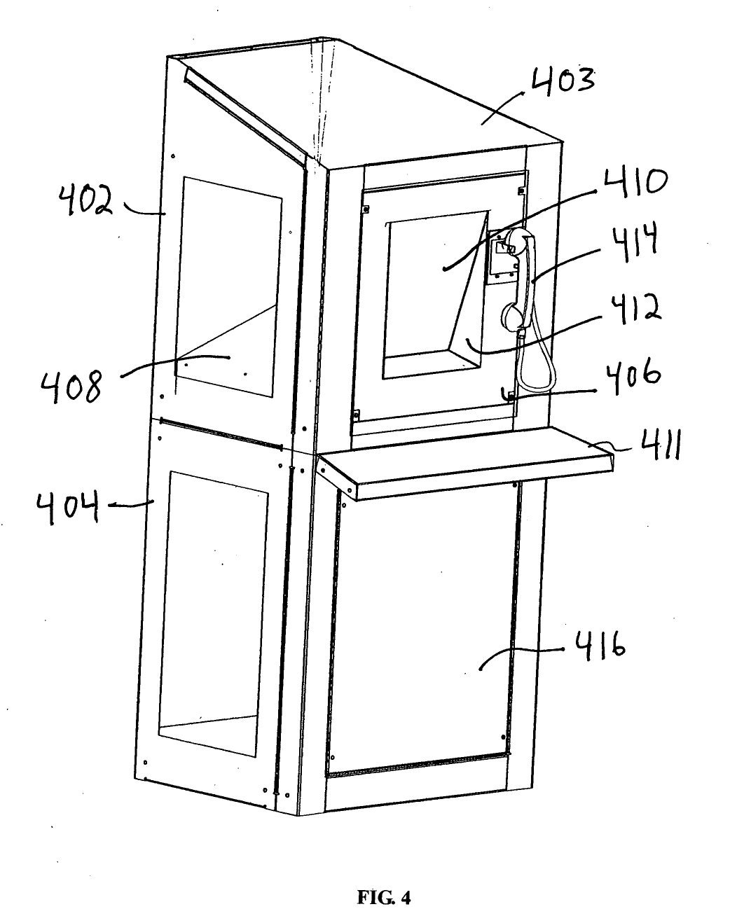

Second station 704 includes a third wall 716 and a fourth wall 718 which are coupled to a second video equipment cabinet 720. Third wall 716 is coupled to the second wall via trapezoidal top plate 708 and corner plate 710. While only two stations are shown in FIG. 7, multiple stations can be deployed in the same fashion. In this embodiment, while the use of space is not maximized to the same extend as in the configuration shown in FIGS. 5-6, this allows the use of the same design but can be deployed against a wall. In some deployments both the design of FIGS. 5-6 and FIG. 7 can be used together with the design of FIGS. 4-5 used in the center of the room and the design of FIG. 6 used against walls in the room.

In use, multiple video conference stations as shown in FIGS. 1-4 and configured in multiple units as in FIGS. 5-6 and FIG. 7 are deployed in the same location such as a prison visitation room. Each of the video conference stations, in one embodiment, can accommodate a pair of individuals. Individuals would be seated at the different station and communicate with inmates using the video conference equipment stored in each station. The inmates are located remote from the video conference stations in the visitation room.

While the previous figures were discussed in relation to the use in a secured environment such as a prison visitation room, the present invention can be used in other locations where a rugged video conference unit is needed. This can include, for example, video phone and conferencing applications in public places such as bus depots and airline terminals. Additionally, the stations can be used in libraries or other public places as terminals for research and distance learning. In one embodiment, the stations are deployed in a circle.

Having now described preferred embodiments of the invention modifications and variations may occur to those skilled in the art. The invention is thus not limited to the preferred embodiments, but is instead set forth in the following clauses and legal equivalents thereof.

1. A video conference station comprising:
an equipment cabinet for retaining video conference equipment;
a first wall enclosing a first side of the equipment cabinet;
a second wall enclosing a second side of the equipment cabinet;
a connector coupling the first wall to the second wall; and
wherein the first wall, the second wall, the connector and an imaginary line across an entrance to the station form a trapezoidal shape.

2. The station of claim 1 wherein the first wall includes an acoustical grating to deaden sound.

3. The station of claim 1 wherein the station accommodates multiple users at the same time.

4. The station of claim 1 wherein the equipment cabinet includes a base portion and a top portion.

5. The station of claim 1 wherein the cabinet has a wedge shape to bolt flush against the first wall and the second wall.

6. The station of claim 1 wherein a line of stations is formed from multiple stations, each of the stations sharing a common wall, and the entrance to each of the stations alternating on either side of the line of stations.

7. The station of claim 1 wherein a line of stations is formed from multiple stations, each of the stations coupled together, and the entrance to each of the stations is on the same side of the line of stations.

8. A video conference station comprising:
a wedge shaped equipment cabinet for retaining video conference equipment;
a pair of walls aligned in a wedge shape, the walls matching with and coupling to the wedge shaped equipment cabinet; and
a connector coupling the pair of walls together.

9. The station of claim 8 wherein an acoustical grating is provided on at least one of the pair of walls to deaden sound.

10. The station of claim 8 wherein the station accommodates multiple users at the same time.

11. The station of claim 8 wherein the equipment cabinet includes a base portion and a top portion.

12. The station of claim 8 wherein a line of stations is formed from multiple stations, each of the stations sharing a common wall, and the entrance to each of the stations alternating on either side of the line of stations.

13. The station of claim 8 wherein a line of stations is formed from multiple stations, each of the stations coupled together, and the entrance to each of the stations is on the same side of the line of stations.

14. The station of claim 11 wherein the top portion of the equipment cabinet has an angled top panel that causes items placed on top of the panel to fall off.

15. The station of claim 11 wherein the base portion stores electronic equipment.

16. A video conference station comprising:
an equipment cabinet having a trapezoidal shape;
a first wall coupled to a first side of the equipment cabinet; and
a second wall coupled to a second side of the equipment cabinet.

17. The station of claim 16 wherein the first wall and second wall are connected by a connector and a corner post.

18. The station of claim 16 wherein an acoustical grating is provided on at least one of the first wall and the second wall to deaden sound.

19. The station of claim 16 wherein the station accommodates multiple users at the same time.

20. The station of claim 16 wherein the equipment cabinet includes a base portion and a top portion.

21. The station of claim 16 wherein a line of stations is formed from multiple stations, each of the stations sharing a common wall, and the entrance to each of the stations alternating on either side of the line of stations.

22. The station of claim 16 wherein a line of stations is formed from multiple stations, each of the stations coupled together, and the entrance to each of the stations is on the same side of the line of stations.

23. The station of claim 20 wherein the top portion of the equipment cabinet has an angled top panel that causes items placed on top of the panel to fall off.

24. The station of claim 20 wherein the base portion stores electronic equipment.
